(19) United States
(12) Patent Application Publication
(10) Pub. No.: US 2022/0373080 A1
(43) Pub. Date: Nov. 24, 2022

(54) SELECTOR LEVER ASSEMBLY FOR SELECTING AND SWITCHING DIFFERENT DRIVING MODES IN A VEHICLE TRANSMISSION

(71) Applicant: ZF Friedrichshafen AG, Friedrichshafen (DE)

(72) Inventors: Carsten Bode, Diepholz (DE); Melanie Wiegmann, Diepholz (DE); Jan Szekeres-Kriselius, Lemförde (DE)

(73) Assignee: ZF Friedrichshafen AG, Friedrichshafen (DE)

(21) Appl. No.: 17/640,615

(22) PCT Filed: Aug. 26, 2020
(86) PCT No.: PCT/EP2020/073850

§ 371 Date: Mar. 4, 2022

(30) Foreign Application Priority Data
Sep. 6, 2019 (DE) 10 2019 213 549.8

(51) Int. Cl. F16H 61/24; F16H 59/10; F16H 61/22

(52) U.S. Cl. CPC F16H 61/24; F16H 59/105; F16H 61/22; F16H 2059/081

(57) ABSTRACT

A selector lever assembly for selecting and shifting to various driving modes in a vehicle transmission may include a rotary knob that is connected to a shaft element supported in a housing, where the driving modes are assigned to the rotational range of the shaft element, and separated from one another by a latching contour that can be felt by a driver, and where the rotation of the shaft element can be blocked by a locking contour, and where the shaft element is connected to a disk element for conjoint rotation, but can be displaced axially in order to activate and deactivate at least one further function mode.

### RELATED APPLICATIONS

This application is a filing under 35 U.S.C. § 371 of International Patent Application PCT/EP2020/073850, filed Aug. 26, 2020, and claiming priority to German Patent Application 10 2019 213 549.8, filed Sep. 6, 2019. All applications listed in this paragraph are hereby incorporated by reference in their entireties.

### TECHNICAL FIELD

The present invention relates to a selector lever assembly for selecting and shifting to different driving modes in a vehicle transmission

### BACKGROUND

Selector lever assemblies for selecting and shifting to different driving modes in a vehicle transmission are sufficiently known from the field of automotive engineering. The selector lever assembly normally comprises a rotary switch that is rotatably supported in a housing, to which the driving modes are assigned over a rotational range, such that driving modes can be selected by turning the rotary switch. The various driving modes are normally separated by a toothed mechanism that can be felt by the driver. Furthermore, certain driving modes are blocked in certain driving situations in a manner obtained with an appropriate locking contour in the selector lever assembly.

By way of example, a shifting assembly is known from U.S. Pat. No. 9,810,314 B2 for changing gears in a vehicle transmission. Various driving modes can be selected in the vehicle transmission using a rotary switch in the shifting assembly. By way of example, the various driving modes are “park,” “neutral,” “reverse,” “drive,” and a manual driving mode, as well as a high-performance driving mode. These various driving modes can be selected using the rotary switch.

The known shifting assembly comprises a rotary knob for this, which is operated by the driver to select the various driving modes. The rotary knob is connected to a selector shaft for conjoint rotation via a splined connection, such that the rotation of the rotary knob is transferred to the selector shaft. The rotation of the selector shaft transfers the corresponding driving mode from the selector shaft in a housing to a control unit for the vehicle transmission. Furthermore, a latching disk is also connected via another splined connection to the selector shaft for conjoint rotation. The outer circumference of the latching disk has numerous teeth that interact with a latching pin to simulate a latching effect during the rotation. There is also a locking disk on the selector shaft, connected thereto for conjoint rotation. The locking disk comprises numerous recesses that corresponding locking pins can engage with, in order to be able to block the rotation of the selector shaft at specific rotational angles. The locking pins are fixed in place in the housing.

### BRIEF DESCRIPTION OF THE DRAWINGS

Certain embodiments shall be explained in greater detail below in reference to the drawings. Therein:

FIG. 1 shows a schematic, cutaway view of a possible embodiment variant of a selector lever assembly according to the invention, when the rotary knob has not been pressed down;

FIG. 2 shows a schematic, cutaway view of the selector lever assembly when the rotary knob has been pressed down;

FIG. 3 shows a schematic, three dimensional view of a shaft element connected to a disk element in the selector lever assembly according to the invention;

FIG. 4 shows a view from below of the selector lever assembly according to the invention shown in FIG. 3;

FIG. 5 shows a three dimensional view of the individual parts of the shaft element in the selector lever assembly according to the invention; and

FIG. 6 shows a view of the individual parts of the disk element in the selector lever assembly according to the invention.

### DETAILED DESCRIPTION

In view of the background above, an object of this disclosure is to describe an improved selector lever assembly

As such, a selector lever assembly for selecting and shifting to various driving modes in a vehicle transmission is proposed that has a rotary knob, which is connected to a shaft element, or the like, supported in a housing. The various driving modes are assigned to the rotational range of the shaft element, and are separated from one another by a latching contour that can be felt by a driver, and the rotation of the rotary switch can also be blocked by a locking contour. In expanding the functionality of the selector lever assembly according to the invention, the shaft element is coupled for conjoint rotation with a disk element, such that it can still be displaced axially, in order to activate and deactivate at least one further function mode.

In this manner, a functional expansion as well as a simplification of the operation is obtained with the proposed selector lever assembly, because, first, a predetermined driving mode can be set by the rotation, while through the additional axial pressing, the so-called “tap down” of an additional function mode can also be obtained. By way of example, a high-performance mode can be activated in the normal driving mode by pressing down on the rotary knob, and then deactivated by pressing it down again. Other functions can also be obtained through the axial movement of the rotary knob. This operating concept with the proposed selector lever assembly is more intuitive, and be obtained in a structurally simple manner.

A particularly simple construction can be obtained in that the shaft element and the disk element are coaxial to one another. By way of example, the shaft element can be connected to the disk element via a splined connection or the like, such that it can be displaced axially and is still connected thereto for conjoint rotation. Other connections, which result in very low radial play in transferring the rotational movement to the disk element, while still allowing for axial movement of the shaft element in relation to the disk element in the housing, are also conceivable.

To further optimize operation of the propose selector lever assembly, a haptic element, or the like, for generating a corresponding tactile feeling when the shaft element is returned axially to its starting position, can be implemented in the framework of another development, which is located between a collar or disk-shaped formation on the shaft element and the disk element. The haptic element results in a corresponding tactile feedback to the driver when the rotary knob is pressed down, such that the driver can feel when the function mode in question has been activated or deactivated. An elastic element such as a spring, or the like, can basically be used for this. In a particularly advantageous embodiment of the invention, the haptic element is a silicone switch plate or the like.

In order to be able to comprise the selection and shifting to the various driving modes as well as the activation and deactivation of the further function mode through the axial movement, there is at least one permanent magnet on the end of the shaft element facing away from the rotary knob, which has a dedicated sensor that can detect its movement. A 3D sensor can preferably be used for this. The sensor is fixed in place in relation to the housing, such that the sensor is dedicated to the permanent magnet, thus enabling it to detect the movement of the permanent magnet, which is connected to the shaft element. Other detection systems can also be used, that enable a corresponding detection of the rotational movement and the axial movement of the shaft element.

A particularly compact construction of the proposed selector lever assembly is obtained in that the disk element has both a latching contour and a locking contour. In this manner, both functions are integrated in a single component. The structural design of the latching contour and locking contour is such that both a latching and a blocking of the rotational movement of the shaft element can be obtained.

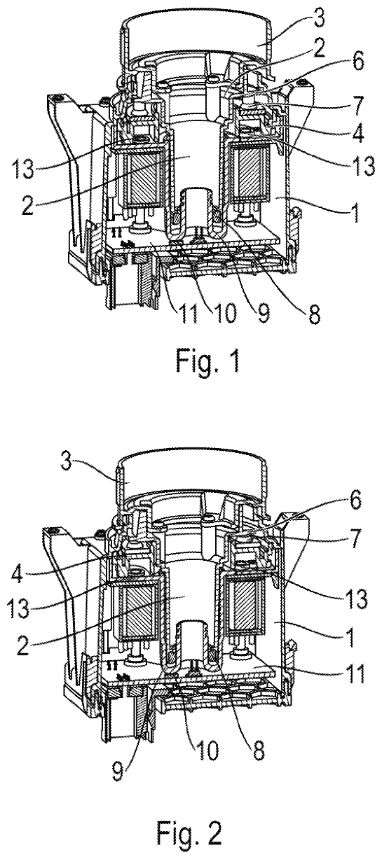

Referring now to the figures, various views of the selector lever assembly or selecting and shifting to various driving modes, e.g. “park,” “reverse,” “neutral,” “drive,” and other driving modes, are shown by way of example in FIGS. 1 to 6.

The selector lever assembly comprises a housing 1, in which a shaft element 2 is rotatably supported, to which a rotary knob 3 is attached. The various driving modes are assigned to the rotational range of the shaft element 2, such that they can be selected by a rotation of the rotary knob 3 by a driver, and thus shifted to. The driving modes are each separated from one another by a latching contour that can be felt by a driver. The rotation of the shaft element 2 can be blocked by a locking contour.

To expand the functionality of the selector lever assembly, the shaft element 2 is connected to a disk element for conjoint rotation, but can still be displaced axially in order to activate and deactivate at least one further function mode.

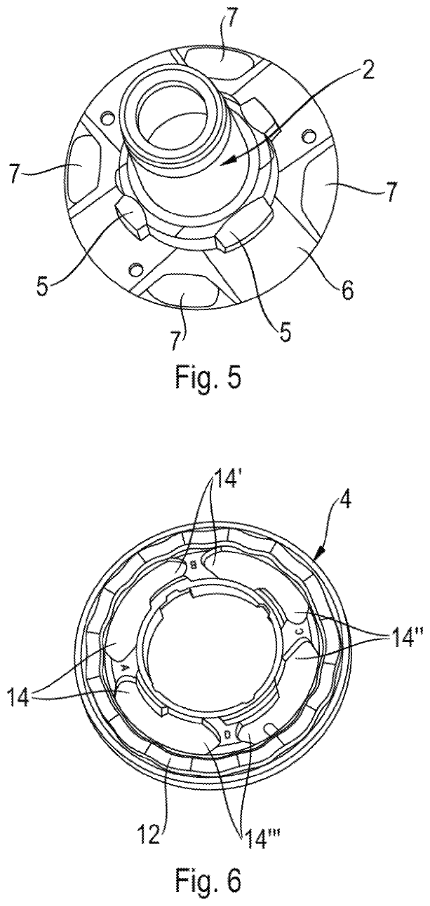

As can be seen in particular in FIGS. 1 to 5, the shaft element 2 and the disk element 4 are coaxial to one another. There is a splined connection 5, by means of which the connection for conjoint rotation is obtained, which results in a connection between the shaft element 2 and the disk element such that they rotate conjointly, while still allowing the shaft element 2 to be displaced axially in relation to the disk element 4 in the housing 1. The splined connection 5 can be seen in particular in FIGS. 4 and 5.

To make the individual driving modes more noticeable to the driver when rotating the shaft element 2, a haptic element is placed between a collar 6 on the shaft element 2 and the disk element 4, which generates a tactile feeling when the shaft element 2 is returned axially to its starting position. A silicone switch plate 7 is used as the haptic element.

There is at least one permanent magnet 8 on the end of the shaft element 2 facing away from the rotary knob 3. The shaft element 2 is inserted with the permanent magnet 8 into a recess 9 in the housing. The permanent magnet 8 on the end of the shaft element has a dedicated sensor 10, fixed in place in relation to the housing, for detecting the rotational and axial movements of the shaft element 2. The sensor is a so-called 3D sensor, which is located on a printed circuit board 11 in the housing, in order to be able to detect the movements of the shaft element 2, or the permanent magnet 8, respectively.

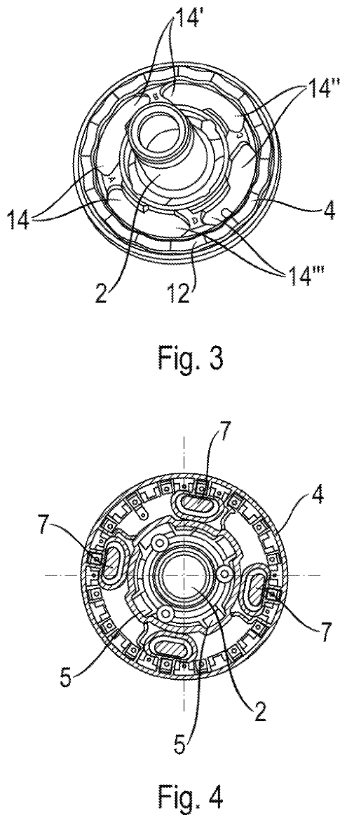

The schematic illustrations of the proposed selector lever assembly shown in FIGS. 1 and 2 show different operating states of the selector lever assembly. FIG. 1 shows the proposed selector lever assembly when it has not been pressed down, and FIG. 2 shows it when it has been pressed down in the axial direction. The shaft element 2 and the disk element 4 in the selector lever assembly are shown in greater detail in FIGS. 3 to 6.

FIGS. 3 and 4 show the shaft element 2 and the disk element 4, which are connected for conjoint rotation, but still allow axial displacement. The illustrations of the individual parts of the shaft element 2 and disk element 4 shown in FIGS. 5 and 6 also show that the disk element 4 has a latching contour and a locking contour. A wave-shaped annular contour 12, which protrudes axially, forms the latching contour on the circumference of the disk element 4. This wave-shaped annular contour 12 is in functional contact with a latching pin, not shown here, such that a corresponding haptic can be felt by the driver during the rotation, in order to separate the various driving modes from one another.

There are numerous bearing or stop regions A, B, C, D on the disk element 4 that form the locking contour, on which a locking pin 13, fixed in place on the housing and able to move in the axial direction, can be brought to bear in order to block the rotation of the shaft element 2. The stop regions A, B, C, D on the locking contour are formed by adjacent recesses 14, 14′, 14″, 14′″ on the disk element. The recesses 14, 14′, 14″, 14′″ form ring segments on the disk element 4, such that a stop element A, B, C, D is formed between each pair of adjacent recesses 14, 14′, 14″, 14′″.

Two locking pins 13 are shown by way of example in FIGS. 1 and 2. Through an axial movement thereof, they are brought to bear on the stop regions A, B, C, D, such that the rotation of the disk element 4, and therefore the shaft element 2 as well, is blocked.

The locking pins 13 are mounted on the housing such that they can move axially. They are pretensioned with a spring, and can be moved axially, e.g. by a magnet, such that the respective locking pin 13 is brought to bear on the stop regions A, B, C, D, thus blocking rotation of the shaft element 2 in one direction, for example. If the rotation of the shaft element 2 is to be blocked in both directions, for example, the rotation of the shaft element 2 is blocked in both directions by numerous locking pins 7, which bear on different stop regions A, B, C, D, in order to make it impossible to deactivate a certain driving mode, even if the driver attempts to do so by applying more force to the rotary knob 3 on the shaft element 2. The rotation of the shaft element 2 is therefore blocked by the active locking pins 13 bearing on the stop regions A, B, C, D. As soon as the blocking is to be deactivated, the locking pins 13 are retracted axially, such that they no longer bear on the stop regions A, B, C, D. The shaft element 2 can then again be moved freely by the driver.

### REFERENCE SYMBOLS

1 housing
2 shaft element
3 rotary knob
4 disk element
5 splined connection
6 collar
7 silicone switch plate
8 permanent magnet
9 recess
10 sensor
11 printed circuit board
12 annular contour
13 locking pin
14, 14′, 14″, 14′″ recesses
A, B, C, D bearing or stop regions

1. A selector lever assembly for selecting and shifting to various driving modes in a vehicle transmission, the selector lever comprising:
a rotary knob connected to a shaft, wherein the driving modes are assigned along a rotational range of the shaft and separated from one another by a latching contour that can be felt by a driver,
wherein the rotation of the shaft is selectively blockable by a locking contour,
wherein the shaft is connected to a disk element for conjoint rotation, and
wherein the shaft is axially movable to activate and deactivate at least one function mode.

2. The selector lever assembly according to claim 1, wherein the shaft and the disk element are coaxial to on another, and connected for conjoint rotation via a splined connection, such that the shaft can be displaced axially.

3. The selector lever assembly according to claim 1, wherein there is a haptic element for generating a tactile feeling and for returning the shaft axially to its starting position, located axially between a collar on the shaft and the disk element.

4. The selector lever assembly according to claim 3, wherein a silicone switch plate forms the haptic element.

5. The selector lever assembly according to claim 1, wherein a permanent magnet is located on an end of the shaft facing away from the rotary knob.

6. The selector lever assembly according to claim 1, wherein the shaft is axially inserted with the permanent magnet into a recess in a housing.

7. The selector lever assembly according to claim 6, wherein the permanent magnet on the end of the shaft has a dedicated sensor fixed in place in the housing, for detecting the rotational and axial movements of the shaft.

8. The selector lever assembly according to claim 1, wherein the disk element has a latching contour and a locking contour.

9. The selector lever assembly according to claim 8, wherein a wave-shaped annular contour that protrudes axially on a circumference of the disk element forms the latching contour.

10. The selector lever assembly according to claim 8, wherein there are numerous stop regions on the disk element that form the locking contour, on which at least one locking pin can be brought to bear, which is fixed in place in the housing and can move axially, to block the rotation of the shaft.

11. The selector lever assembly according to claim 10, wherein each stop region is formed between adjacent recesses on the disk element.
